(19) United States
(12) Patent Application Publication
(10) Pub. No.: US 2011/0055056 A1
(43) Pub. Date: Mar. 3, 2011

(54) Systems, Processes and Methods of Financing Entertainment Projects and Products Thereby

(75) Inventor: Jeff Kwatinetz, Malibu, CA (US)

(73) Assignee: PROSPECT PARK LLC, Los Angeles, CA (US)

(21) Appl. No.: 12/549,299

(22) Filed: Aug. 27, 2009

(51) Int. Cl. G06Q 10/00; G06Q 40/00; G06Q 50/00

(52) U.S. Cl. 705/30

(57) ABSTRACT

Systems, processes and methods of financing an entertainment project such as a feature film comprising the public offering for sale of a limited-life vehicle such as shares of common stock in a corporation whose primary asset is the project such that buyers (investors) become beneficial owners of the entertainment project, using the proceeds associated with the sale of the vehicle to produce the project, providing for the registration of the security instrument evidencing the vehicle, and paying to investors periodic returns such as distributions based upon the revenues of the entertainment project.

### FIELD

The present disclosure relates to financing systems and methods. In particular, the present disclosure relates to novel financial and investment instruments and to value generation scenarios relative to feature films, television shows and other entertainment projects utilizing limited-life investment vehicles in the public markets.

### BACKGROUND

Though there is wide interest in and appreciation of motion pictures by the consuming public, the process of financing film production has traditionally been limited to motion picture studios and independent productions financed by private investors. Because of their greater market power, the bulk of high-quality film projects are offered first to the studios, leaving independent investors to choose from rejected projects. Moreover, known methods of film finance suffer from a high degree of inconsistency, lack of transparency, uncertainty and lack of investor confidence concerning whether the project will be completed, whether accounting will be done fairly and equitably, whether there will be full and fair disclosure of financial results, whether payments to above-the-line talent will reduce or eliminate investor returns, and whether distributions will be made promptly. Studios, producers and investors attempt to estimate potential return on investment (ROI) by assessing various elements of a film, including the actors and directors involved in a project, and whether a storyline seems to appeal to a particularly desirable demographic group or a broad cross section of the consuming public. Accordingly, it is typically films with well-known actors and directors, familiar genres, and plots similar to prior profitable films that are approved for production, financed and made for public consumption. However, nothing particular about the nature of entertainment projects or financing dictates this structure.

The primary means of financing non-studio films is foreign pre-sales, i.e., selling the distribution rights in a film in different territories before the film is produced. A film producer may then use the value of those distribution contracts as collateral for a production loan. Studio executives who “green-light” studio films for production and distributors of independent films often insist that a film contain certain elements of content and cast to maintain a higher chance of financial success. This may limit and constrain the creative process, and if a major change in one of these elements occurs the approval or financing may collapse. Studio executives and distributors often suggest certain casting alterations to bring in top stars who they think will make the film a success. Thus, the studio and pre-sales models lead to repeated dependence on the same stars, directors and film genres, with those decisions made by the same small group of people. This has limited appeal to most investors, and to the public at large who might otherwise be interested in investing in motion pictures, particularly those of films of interest to them or which they believe might have good financial returns.

Attempts have been made to predict the profitability of motion picture projects such as feature films and television programming by using models that take into account characteristics such as genre and budget and select projects for financing. However, such systems typically require selections to be approved by a committee, which generally comprises representatives of the investors, the production company and other film industry people. Thus, it is artificial models and individuals from the established closed circles of film finance ultimately deciding which pictures get made, not the public, even though the public will ultimately determine the commercial success of the film by its attendance. After a picture is financed, investors must often wait years to be repaid until after the project is produced, marketed, distributed and released, and a final accounting of profits is provided.

Therefore, there exists a need for an entertainment financing method that can make investing in film and television production and other entertainment properties more appealing to investors by providing fair, consistent and transparent accounting, as well as prompt distributions as soon as revenues are received, rather than waiting for the project to turn a profit before any distribution is made. In addition, compensating participants in the production with equity rather than cash enables them to share in future revenues, while at the same time lowering the amount of cash needed and thereby increasing ROI for providers of financing. Investors will be paid pari passu with such participants, so that members of the broad investing public will receive their first distribution checks at the same time as leading actors and directors. There also is a need for a financing system that opens up the process of funding films and other entertainment projects to the wider public, to spread the risk and to provide greater public influence over which films are made.

Likewise, provision of mechanisms to enhance visibility of the process and underlying deal structure may offer vehicles embodying the instant teachings a higher degree of traction than extant systems. Though several aborted attempts have been made to finance motion pictures through public offerings all have been based on existing film finance structures and were unsuccessful in meeting the needs of the investing public for an offering that has greater transparency and a higher level of confidence in financial structure, financial disclosure, and corporate governance. For these reasons, inter alia, long-standing needs are met by the teachings of the instant disclosure.

### SUMMARY

The present disclosure, in its many embodiments, provides systems and methods of financing entertainment projects involving offerings of equity ownership so that a population such as the general public can have an ownership interest in entertainment projects such as feature films, television programs and musical recordings. Equity securities such as shares of common stock of a corporation holding rights to a project such as a film may be publicly traded after an initial public offering of the shares. A public offering and limited-life company trading vehicle provides a mechanism for effective equity compensation of project participants, a higher level of financial confidence for potential investors, and diversifies the risk of investing in a film project. It also provides a mechanism to allow more public involvement in financing a project which facilitates greater public influence over what films are commercially viable and what films ultimately are financed, produced and released for public consumption. The disclosed system and method, can be a platform wherein, in a preferred embodiment, an investment in the entertainment project, the company created, and the offering are economically one and the same thing. According to embodiments, a method and system of financing an entertainment project is provided. In some instances the method or system comprises publicly offering for sale shares of common stock in a corporation holding rights to a feature film such that buyers of the shares of common stock become beneficial owners of the motion picture. The public offering may be in the form of an underwritten initial public offering (IPO). In some instances, the public offering occurs prior to production of the entertainment project and finances the production, distribution and marketing of the entire project. The revenue generated from the sale of the securities is used to produce the entertainment project. The method or system also includes providing for public trading of the shares via a national quotation system or exchange. Revenue distributions will be paid starting upon receipt of revenues and lasting for a period of time, such as three to five years from the initial public release of the entertainment project, during which time the majority of projected lifetime revenues for the project will have been received. In some instances the time period for public trading may start the date the offering is completed, or when certain aspects of the project have met a threshold level, or been publicly announced. A non-inclusive list of some of the variables which may be such aspects of the project include creative talent such as screenwriters, directors and actors, and financial and operational management such as producers, sales agents and distributors.

Preferably the value of the equity securities offered is sufficient to finance the entire entertainment project, although the disclosed methods could be used to partially finance an entertainment project. An entertainment project is a general category which includes, but is not limited to audio-video projects such as motion pictures, feature films and television programs, sound recordings such as music albums, and production of live events such as Broadway musicals, plays and music concerts. In one implementation, the public offering occurs after completion of the entertainment project to raise money for marketing purposes such as film prints and advertising. Further, the method or system may include offering equity participation to above-the-line talent featured in the entertainment project in lieu of some or all of their monetary compensation. The producers of the entertainment project may serve as management, e.g. officers or directors of a corporation, or managers of a limited liability company owning or holding rights to the project. In a preferred embodiment, the entity is a corporation, the equity is common stock, and the entertainment project is a feature film. The disclosed systems and methods also could be used to finance a group or slate of entertainment projects.

Shareholders who are involved with or working on the entertainment project may be prohibited from trading their shares prior to launch of the entertainment project, to prevent insider trading.

Distributions can be made to equity holders periodically as soon as the project begins to generate revenues, whether from the sale of rights, foreign pre-sales, theatrical box office, or ancillary markets. Periodic distributions may be made monthly or quarterly for three to five years after the launch of the entertainment project, or for any other period reflecting the revenue associated with or generated during the life span of the project. The financing method includes paying one or more final distributions to the shareholders at the end of one or more pre-determined time periods, based upon an actual sale or formula valuation. In some embodiments, the final distribution corresponds to a pre-determined percentage of the net present value of the project, with the current value being estimated based on projected remaining future income of the entertainment project. The method may also include selling all remaining rights in the entertainment project and distributing the sale proceeds among the equity holders.

In other embodiments, methods or systems of financing an entertainment project are provided comprising offering for sale membership interests in a limited liability company such that buyers of the membership interests become beneficial owners of the entertainment project, appointing managers of the company, using revenue from sale of the membership interests to make the entertainment project, and paying periodic distributions to members from revenues received. The limited liability company's existence will be limited to a finite, pre-determined time period. A limited existence may be three to five years, or tied to when anticipated revenues are likely to be received.

Accordingly, it is seen that systems and methods of financing entertainment projects are provided in which public offerings of securities are made so the ROI can be increased and the general public can have an ownership interest in the entertainment projects. The securities may be publicly traded after an initial public offering, and revenues may be distributed to equity holders. These and other features of the present disclosure will be appreciated from review of the following detailed description, along with the accompanying figures.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a flow chart showing embodiments of the disclosed financing system and method;

FIG. 2 is a flow chart showing an exemplary implementation of an initial public offering conducted in accordance with an embodiment of the disclosed financing system and method.

### DETAILED DESCRIPTION

In the following paragraphs, embodiments of the present disclosure will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects. Reference to dollar amounts, corporate entities, percentages, proportions and other parameters should be considered as representative and illustrative of the capabilities of embodiments of the present disclosure, and embodiments can operate with a wide variety of such parameters.

Expressly incorporated by reference herein are U.S. Publication No. 2005/0108131; and U.S. Publication. No. 2007/0100641; Josh Friedman, For Film Financing, Try an IPO, Los Angeles Times, Jul. 14, 2003; Shyam G. Menon, Bollywood breaks financing tradition—Study finds sharp rise in private equity, dip in institutional lending, Hindu Business Line, available at:

http://www.thehindubusinessline.com/2005/04/04/stories/2005040402090100.htm;
Travis Johnson, Marvel's New Movie Financing Concept (MVL), May 17, 2006, available at:
http://seekingalpha.com/article/10869-marvel-s-new-movie-financing-concept-mvl;
Steven Pearlstein, Big Deals Are Sequels to Tradition in Hollywood, The Washington Post, May 17, 2006, available at:
http://www.washingtonpost.com/wp-dyn/content/article/2006/05/16/AR2006051601828.html;
Film Investment—A Capital Idea, American Way, available at:
http://www.americanwaymag.com/billy-dead-civilian-capital-online-brokerage-microsoft;
Gun-Jumping—Lessons in Dealing With the Media, Mar. 25, 2004, TheCorporateCounsel.net Blog, available at: http://www.thecorporatecounsel.net/blog/archive/000117.html.

The present disclosure provides systems and methods of financing entertainment projects, including motion pictures, which comprise a public offering of common stock or other sale of equity interests in a limited-term entity holding rights to an entertainment project. The shares of stock or other financial interests may provide a higher level of financial confidence to potential investors than existing methods of entertainment project finance, spread the risk of financing the entertainment project, and provide the consuming public with some control over what motion pictures are made and released. After the entertainment project is announced or released, the shares are publicly traded. Revenues may be distributed to the equity holders based on the success of the entertainment project.

The following example generally illustrates aspects of implementations of a financing system in connection with motion pictures. A major motion picture studio, mini-major or independent film producer, “Producer,” wants to produce a feature length motion picture, “Film,” based on the rights to an existing screenplay. The film has one well-known actor, “St A”, a mid-level actor, “Star B,” and a relative unknown, “Star C.” Producer hopes to obtain the services of an accomplished director, “Director,” to direct the picture. Producer estimates the cost of development to be approximately $5 million and the cost of production to be $45 million. In addition, prints and advertising costs are projected at approximately $35 million DVD and foreign release costs are estimated at $15 million.

Producer forms a corporation for the motion picture project, “Corporation,” and arranges for a public offering of the common stock in Corporation. As described in more detail below, the Producer files a registration statement with the U.S. Securities and Exchange Commission (SEC). A portion of the registration statement, called the prospectus, would contain information about Film for potential shareholders. The prospectus would also contain provisions about revenue distributions over the revenue generating life of the film.

Producer may engage the services of an investment bank to underwrite an initial public offering (IPO) for Corporation calculating the IPO price such that the funds raised will finance the entire Film, including developing, producing, distributing and marketing the motion picture, on all released formats and in all territories. Thus, in this example, the common stock of the IPO comprises 20 million shares, each priced at $5 per share, with Producer and other elements also retaining some portion of Corporation's issued and outstanding stock. Having the investment bank as an underwriter may provide further assurance that Corporation would be able to raise the full funding amount for Film. The investment bank may find investors by marketing to its clients or doing presentations or road shows to target potential investors. Buyers of the stock become shareholders of Corporation and beneficial owners of the rights to Film held by Corporation. Those of ordinary skill in the art will realize that the methodology is not limited to the exact steps or sequence described herein. For example, the offering may be an event other than a traditional IPO, it may be any legal form or combination of institutional, private or public fundraising. In some instances following an underwritten IPO, the shares for Corporation may be traded among the investing public on a public exchange, e.g., the NYSE Amex or the NASDAQ. In some instances the time period for trading may start upon the date the entertainment project commences, or has been publicly announced in entertainment industry trades. A non-inclusive list of some of the variables that may be important aspects of Film include but are not limited to, the screenwriter, director and actors, as well as producers, sales agents and distributors. In some instances, the pre-determined period of time for trading reflects the financial life span of Film. Typically, this time period would be about three to five years. Individuals who are involved in the production of Film, including the director and lead actors, may be given stock in exchange for their services and become shareholders of Corporation. Also, participants may choose to purchase stock in the offering, or in the open market following an IPO.

Non-insider shareholders may buy or sell their shares as they chose based on their own criteria as to whether Film will be a financially successful release. There are many public sources of information on the motion picture industry, including “behind the scenes” news about films in development and production. These sources include entertainment television shows, industry trade publications, and many Internet websites. Investors and potential investors can study and analyze this information, as well as public filings made by Corporation.

After the offering, funds are collected from the investors and remitted to Corporation. Producers use a portion of the capital raised to finish development of Film, including hiring and finalizing contracts with additional talent and service providers. The motion picture is filmed and edited, using the proceeds from the offering to pay for production. The Film is then released in motion picture theaters, using raised funds to pay for film prints and advertising.

The following example illustrates one set of events that may follow a project and is in no way disclosed as a limitation: Film has a successful opening weekend at the box office, and the price per share of stock in Corporation increases from $5 to $10 per share. An investor who bought 1,000 shares in Corporation at the price of $5 per share now holds stock worth $10 per share, increasing the value of his or her holdings from $5,000 to $10,000. In some instances, Producer may have made money by being an investor in Corporation. Alternatively, or in addition to being a shareholder, Producer may have received compensation from Film for managing the project as disclosed in the prospectus.

Rather than waiting for the project to turn a profit before returning anything to investors, as soon as a motion picture begins to generate revenues, equity holders will receive distributions. Distributions may be made in any selected fashion including, but not limited to, monthly or quarterly for a finite, pre-determined period of time from the release of the motion picture. This period might be three to five years or some other period that reflects the financial life span of the motion picture. The dividends are based upon the revenues generated by the Film and the number of shares owned by each shareholder. At the end of the pre-determined time period, a final distribution will be made to shareholders. The distribution could be made based upon a formula, or the Film could be sold to a buyer interested in the remaining revenue streams, and the proceeds distributed among the shareholders.

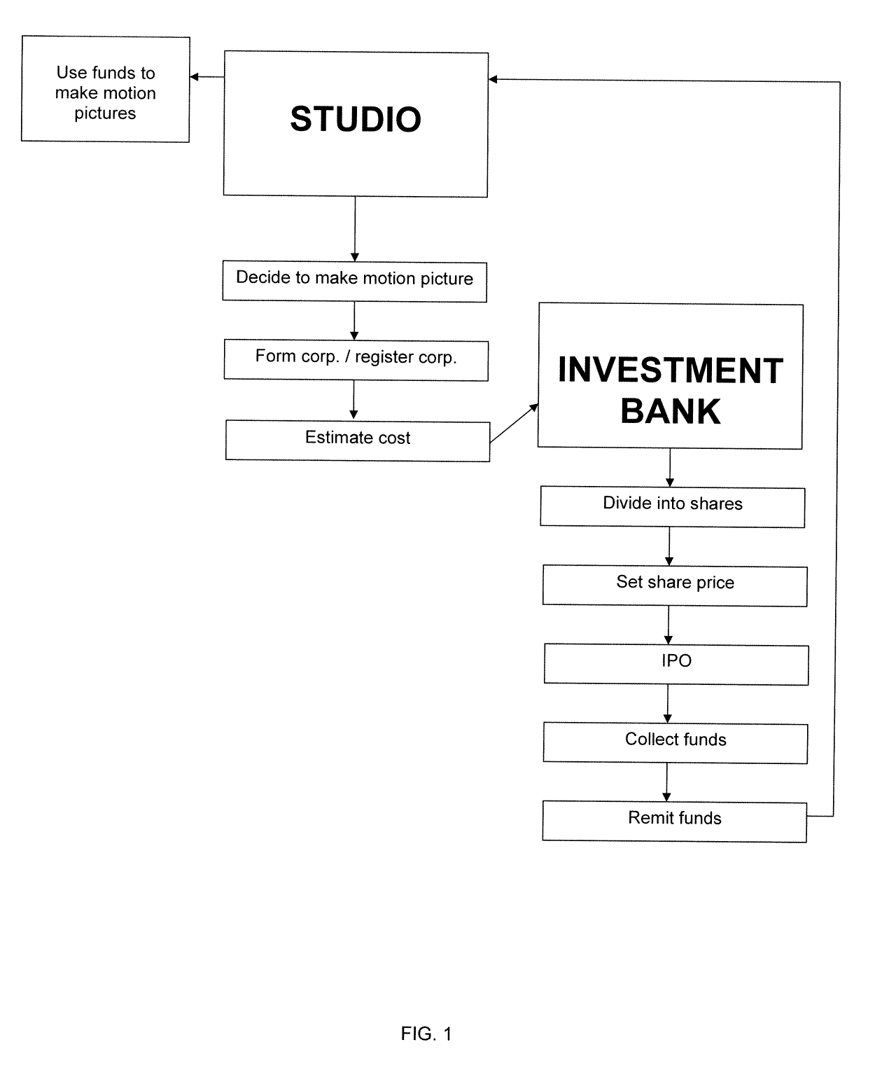

Turning to FIG. 1, a flow chart demonstrating implementation of embodiments of the disclosed financing system and method is provided. First, a studio or producer decides to make a motion picture. Next the producer forms a corporation by registering with a secretary of state's office. The corporation's purpose is to make the particular motion picture. The producer estimates the total cost of the project, including development, production, distribution and marketing budgets.

At this point, the producer may consult an investment bank. The investment bank may assist the corporation in an IPO, including setting share price and helping to find investors. The Corporation sells shares of stock to investors through the investment bank, which collects the funds from the investors. The studio itself will likely invest in the project via the corporation. The investment bank collects the funds from the investors then remits the funds to the corporation, which uses the capital to develop, produce, distribute and market the motion picture.

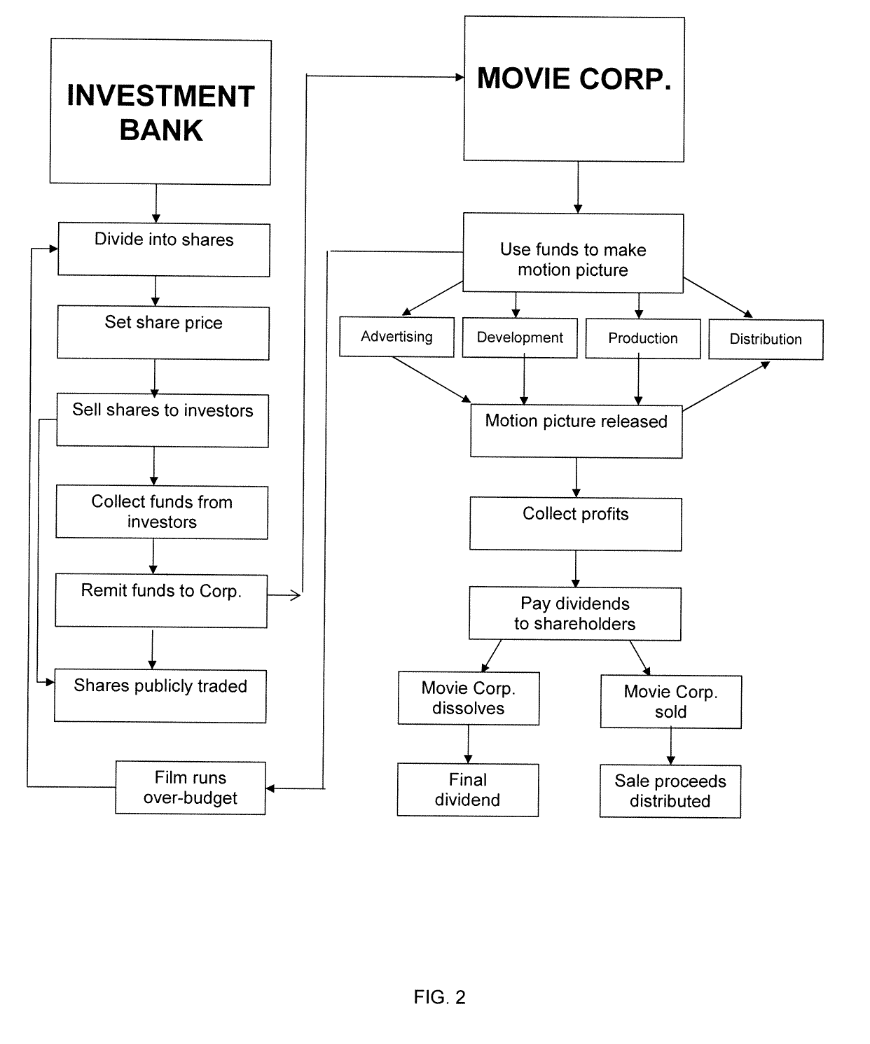

FIG. 2 is a flow chart demonstrating embodiments of an IPO process according to embodiments of the instant teachings in greater detail. When the studio approaches the investment bank about assisting with an IPO for a corporation, the investment bank may investigate the revenue prospects of the film, and the financial needs of the motion picture project. The investment bank may also attempt to gauge interest from its pool of potential investors and clients of the bank. Based on all of this information, the investment bank may decide to underwrite the IPO. This could occur in several ways. First, the investment bank could agree to a firm commitment underwriting and purchase from the corporation all shares of stock offered at a discount to the public offering, then immediately resell the shares to the general public. Alternatively, the investment bank may only agree to use its best efforts to find investors, and only purchase shares to the extent they are repurchased by the public. A bonding firm or insurance company also could be used to guarantee completion of the film, providing additional assurance to investors.

The studio files a registration statement with the SEC, which describes the offering and the issuer. This filing would contain the required information, including the type of business, and information on management of the corporation. The registration statement would include a prospectus to provide information to potential investors. The prospectus might include provisions about the life of the entity, distribution parameters, and other relevant information. For example, a limited liability company might have a limited life and be dissolved three to five years after the motion picture is released. The prospectus might provide that at that time, the rights to future revenues would be sold and any remaining assets would be distributed to the members in cash. In addition, details about the motion picture project and various contingencies will be explained in the prospectus.

The investment bank determines the initial valuation of the equity securities. The price of the public offering may be negotiated between the company and the investment bank, and preferably would be sufficient to finance the entire motion picture project. A certain portion of the shares is retained by the producer or studio, which will thereby retain an ownership interest in the film. The shares are then offered to the public, including investors targeted by the investment bank, for purchase. Some shares may be offered to individuals involved in the production of the motion picture, including the above-the-line talent such as the director and marquee actors in lieu of part or all of their monetary compensation. Various compensation choices could be outlined in the prospectus. However, to prevent insider trading, any shareholder working on the motion picture or involved with it in any way will be prohibited from trading their shares in the motion picture prior to its initial release or during other blackout periods.

The investment bank then collects funds from the investors and remits the funds to the company. The company uses the funds to pay for the motion picture project. Some of the raised capital may go to development of the film such as hiring screenwriters. Some of the capital would pay the salaries of the people involved in the development and production of the motion picture, including above-the-line talent. Costs associated with distribution would also be paid for out of the funds, and the advertising marketing budget would come from the funds.

The shares may be publicly traded after the IPO. The per share value of the stock would vary based on the market's changing perceptions of the likelihood the motion picture will be financially successful. Items that may impact such perception include when certain aspects of the project have met a threshold level, have been decided or announced. Developments such as the box office opening could cause major fluctuations in share price. Trading of shares may also act to increase public awareness of and interest in the film.

If sufficient funds are raised in the offering, the film is produced. If the picture project later runs over-budget, a secondary offering can be made, in which additional shares are offered to the public. This raises additional financing but has the effect of diluting existing stockholders percentage ownership. A follow on offering also could be conducted for discrete portions of the motion picture project such as film prints and advertising. It should be noted that the corporation and its shareholders, including the director, producers and actors holding shares, would have a major incentive to keep the project within the budget because a second offering would dilute their ownership interests as well. In addition, future offering could be compromised if a studio develops a reputation for running over-budget.

After release of the motion picture, the corporation may start to earn revenues through the sale of rights or box office returns. As the corporation receives revenues, it will make distributions to its shareholders. Distributions will be made periodically, such as monthly or quarterly, for a finite, pre-determined period of time starting upon release of the motion picture. This period might be three to five years or some other period that reflects the motion picture's revenue generation life span. The distributions are based upon the revenues of the motion picture and the number of shares owned by each shareholder. The pre-determined time period may correspond with the life of a limited liability company. If and when a company goes into dissolution, a final distribution will be issued to members based upon a formula, corresponding to a pre-determined percentage of a current value of the membership interests with the current value estimated based on projected remaining future income of the motion picture. Alternatively, the project or entity could be sold to a buyer interested in the remaining revenue streams, and the proceeds distributed among the equity holders.

It is contemplated by this disclosure that a studio or producer could have an IPO for discrete portions of a motion picture project. In a hypothetical example, Producer has completed production of Film and decides to raise $10 million for film prints and advertising of the motion picture. An important distinction between doing an offering to finance the entire motion picture project and doing the offering post-production is that the market of potential investors already may have a more definitive perception of the motion picture's potential for success. Because the picture has already been filmed, there is no longer a risk of completion.

Furthermore, a producer or studio could do an offering to finance a grouping of motion pictures or an entire slate of films. For example, an IPO might be done for an entire slate of films by a particular Director, or featuring a particular actor. The studio's budget calculations would be adjusted to reflect the cost of multiple projects, and the investment bank would have to conduct more due diligence. An IPO might have a larger offering and require a larger pool of investors. Whether the IPO is for a single project or a group or slate of projects, the investment bank will try to determine if there is a market for the IPO and what initial share price such market will bear.

It should be noted that those of ordinary skill in the art will realize that any entity, public or private, could be created by a movie studio or producer to raise capital to make a motion picture. In another embodiment, a producer or studio seeking to raise money for a motion picture project would form a limited liability company for the purpose of making the film.

In another hypothetical example, a music Producer might create a limited liability company for the purpose of funding and making a music album, by filing articles of organization with the secretary of state's office. The Company then offers membership interests to potential investors. Producer drafts an operating agreement for Company containing provisions about distributions to members, the life span of the Company and other provisions for governing the Company. The capital raised from selling membership interests is used to develop and produce the recording. Once the recording is released, Company will pay periodic distributions to its members as the project generates revenues. The distributions may be monthly or quarterly for a limited time period starting after the project is released. After a period of time, which may be pre-determined based on the anticipated financial life span of the project, Company may be terminated and final distributions paid to members.

The disclosed systems and methods can be used to finance any type of entertainment project, including, but not limited to, both full length and short motion pictures, television programs, live theater productions, plays, musicals, copyrightable materials, branding, musical recordings, concerts, books, art exhibitions, dance productions and performance art.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

All references listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant.

Thus, it is seen that systems and methods of financing entertainment projects are provided. While the methods and systems have been described in terms of what are presently considered to be the most practical and preferred embodiments, it is to be understood that the disclosure need not be limited to the disclosed embodiments, and it will be evident to one skilled in the art that various changes and modifications may be made therein without departing from the disclosure. It is intended in the appended claims to cover all such various modifications and similar arrangements that fall within the true spirit and scope of the disclosure. The scope of the claims should be accorded the broadest interpretation so as to encompass all such modifications and similar structures.

Such equivalent, broader, or even more generic terms should be considered to be encompassed in the description of each element or action. Such terms can be substituted where desired to make explicit the implicitly broad coverage to which this disclosure is entitled. It should be understood that all actions may be expressed as a means for taking that action or as an element which causes that action. Similarly, each physical element disclosed should be understood to encompass a disclosure of the action which that physical element facilitates.

It should be understood that for practical reasons and so as to avoid adding potentially hundreds of claims, the applicant has presented claims with initial dependencies only. Support should be understood to exist to the degree required under new matter laws—including, but not limited to, United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to, or actually relinquished, such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible.

It should also be understood that a variety of changes may be made without departing from the essence of the disclosure. Such changes are also implicitly included in the description. They still fall within the scope of this disclosure. Further, each of the various elements of the description and claims may also be achieved in a variety of manners. This disclosure should be understood to encompass each such variation, be it a variation of an embodiment of any system embodiment, a method or process embodiment, or even merely a variation of any element of these. The present disclosure includes any and all embodiments of the following claims.

What is claimed is:

1. A method of financing an entertainment project comprising:
publicly offering for sale equity interests in a legal entity with a limited period of existence;
wherein the entity holds rights to an entertainment project such that buyers of the equity become beneficial owners of the entertainment project;
wherein a registration statement for the sale of the securities is filed with the United States Securities and Exchange Commission before offering the securities for sale;
disclosing all material terms of the project in the prospectus;
wherein a registration statement for the sale of the securities is declared effective by the United States Securities and Exchange Commission before selling the securities;
using the proceeds generated from the sale of the equity to produce, distribute and market the entertainment project;
using the revenues generated from the entertainment project to pay periodic distributions pari passu to all common equity holders;
calculating financial statements in accordance with generally accepted accounting principles;
wherein the financial statements are audited by a certified public accountant at an independent registered public accounting firm;
equity holders may sell their securities in the public markets; and
dissolving and winding-up the entity after a pre-determined period of time.

2. The method of claim 1, wherein the proceeds from the sale of equity is sufficient to finance the full anticipated budget for producing, distributing and marketing the entertainment project.

3. The method of claim 1, wherein the entity is a corporation and the equity is shares of common stock.

4. The method of claim 3, wherein the producers of the project are officers or directors of the corporation.

5. The method of claim 1, wherein the entity is a limited liability company and the equity is membership interests.

6. The method of claim 5, wherein the producers of the project are managers of the limited liability company.

7. The method of claim 1, wherein the entertainment project is a feature length motion picture or television program.

8. The method of claim 7, further comprising a screenwriter, director or principal actor being attached to the film before completion of the offering.

9. The method of claim 8, further comprising above-the-line talent accepting shares of common stock as compensation.

10. The method of claim 9, where no above-the-line talent receives any profit participation in the picture other than shares of common stock.

11. The method of claim 10, where no participant receives any compensation other than shares of common stock or cash.

12. The method of claim 11, further comprising restrictions on the ability of above-the-line talent to sell their shares of stock during designated periods or for a period of time after completion of the offering.

13. The method of claim 12, where the restrictions include any time before release of the film or premiere of the television program.

14. The method of claim 7, wherein the entertainment project is a slate of multiple feature films or television series.

15. The method of claim 14, further comprising a slate that is related by having the same director, producer, lead actor, screenwriter or genre for each of the films comprising the slate.

16. The method of claim 1, wherein the entertainment project is an album length musical recording.

17. The method of claim 16, further comprising a recording artist being attached to the project before completion of the offering.

18. The method of claim 17, further comprising a recording artist, musician, songwriter or producer accepting shares of common stock as compensation.

19. The method of claim 18, where no recording artist, musician, songwriter, or producer receives any profit participation in the project other than shares of common stock.

20. The method of claim 19, where no participant receives any compensation other than shares of common stock or cash.

21. The method of claim 20, further comprising restrictions on the ability of talent to sell their shares of stock during designated periods or for a period of time after completion of the offering.

22. The method of claim 21, where the restrictions include any time before release of the recording.

23. The method of claim 3, wherein no issuance of shares of preferred stock is authorized without stockholder approval.

24. The method of claim 1, wherein no issuance of convertible securities is authorized without stockholder approval.

25. The method of claim 3, wherein no issuance of shares of common stock beyond the stated amount of the full public offering is authorized without stockholder approval.

26. The method of claim 4, wherein no issuance of membership interests beyond the stated amount of the full public offering is authorized without stockholder approval.

27. The method of claim 1, wherein periodic distributions are made at least annually when the entertainment project generates revenues.

28. The method of claim 1, wherein periodic distributions are made quarterly for approximately two years after the entertainment project begins to generate revenue.

29. The method of claim 1, wherein the rights to the project are sold and a final distribution is made to equity holders after a majority of projected proceeds from the project are received.

30. The method of claim 29, wherein the final dividend corresponds to a pre-determined percentage of the net present value based on projected remaining future income of the entertainment project.

31. The method of claim 1, further comprising selling the entertainment project and distributing the sale proceeds among the equity holders.

32. A system of financing an entertainment project comprising:
an initial public offering of equity interests in an entity holding rights to an entertainment project such that buyers of the equity become beneficial owners of the entertainment project;
pursuant to an effective registration statement for the sale of securities;
with the equity interests to be quoted or listed for sale on a national quotation service or national securities exchange after completion of the offering;
using the proceeds generated from the sale of the equity to produce, distribute and market the entertainment project;
periodically publicly reporting the financial results of the entertainment project in accordance with generally accepted accounting principles, as audited by certified public accountants at an independent registered public accounting firm; and
equity holders may sell their purchased securities in the public markets.

33. The system of claim 32, wherein the proceeds from the sale of equity is sufficient to finance the full anticipated budget for producing, distributing and marketing the entertainment project.

34. The system of claim 32, wherein the entity is a corporation and the equity is shares of common stock.

35. The system of claim 32, wherein the entertainment project is a feature length motion picture.

36. The system of claim 35, wherein the entertainment project is a slate of multiple feature length motion pictures.

37. The system of claim 32, wherein the entertainment project is an album length musical recording.

38. The system of claim 37, wherein the entertainment project is a series of album length musical recordings by a single recording artist.

39. The system of claim 32, wherein the initial public offering is completed before production of the entertainment project.

40. The system of claim 32, wherein the initial public offering is completed before release of the entertainment project.

41. Products, by the process of claim 1.

42. Products, by the system of claim 32.
